(19) United States
(12) Patent Application Publication
(10) Pub. No.: US 2022/0047013 A1
(43) Pub. Date: Feb. 17, 2022

(54) FOLDED MASK SYSTEMS AND METHODS

(71) Applicant: Sarah Nabai, Del Mar, CA (US)

(72) Inventor: Sarah Nabai, Del Mar, CA (US)

(21) Appl. No.: 17/399,359

(22) Filed: Aug. 11, 2021

Related U.S. Application Data
(60) Provisional application No. 63/064,030, filed on Aug. 11, 2020.

(51) Int. Cl. A41D 13/11

(52) U.S. Cl. CPC A41D 13/1115; A41D 13/1161

(57) ABSTRACT

Folded mask systems and methods for providing protection to a wearer and to other individuals located in proximity to the wearer.

### CROSS-REFERENCES TO RELATED APPLICATIONS

This application claims the benefit of U.S. Provisional Patent Application No. 63/064,030 filed Aug. 11, 2020, the content of which is incorporated herein by reference.

### BACKGROUND OF THE INVENTION

Embodiments of the present invention relate to the field of masks, and in particular embodiments, to folded mask systems and methods.

Over the last several decades, both medical professionals and the general public have become far more aware of the dangers of pathogens in bodily fluids, including exhaled breath. Some of the pathogens themselves have become increasingly virulent, and drug resistance has become an issue with strains of bacteria that were once easily eradicated using standard antibiotics. Products that are intended to prevent a medical practitioner from coming into contact with potentially infectious bodily fluids are referred to generally as body substance isolation (BSI) equipment. One of the most common types of BSI equipment is the face mask. Face masks exist in several forms, perhaps the most common of which is the filter mask. A filter mask typically includes a piece of material that is worn over the nose and mouth to filter the incoming and outgoing breath and to prevent the patient's bodily fluids from coming into contact with much of the face, thus preventing the wearer from being infected by others and others from being infected by the wearer. The filter mask is typically tied around the back of the head and neck, or includes elastic straps that are looped over the ears. Medical providers, like surgeons and dentists, typically wear this kind of face mask during most surgical and other invasive procedures, and some patients with chronic conditions, like tuberculosis, may routinely wear filter masks to prevent others from becoming infected. Although such masks are useful in many situations, still further improvements are desired. Embodiments of the present invention provide solutions to at least some of these outstanding needs.

### BRIEF SUMMARY OF THE INVENTION

Embodiments of the present invention include folded mask filter systems and methods that can be used to prevent the wearer from inhaling detrimental airborne particles and also to prevent the wearer from exhaling such particles into the ambient environment.

In one aspect, embodiments of the present invention encompass folded face mask filters having unique folding configurations. For example, a folded face mask device may include a mask panel, and two ear loops attached with the mask panel. The mask panel can have a first fold, a second fold, and a third fold, where the third fold is reverse to the first and second folds.

### BRIEF DESCRIPTION OF THE DRAWINGS

FIGS. 1A and 1B illustrate aspects of folded mask systems and methods, according to embodiments of the present invention.

FIG. 2 illustrates aspects of folded mask systems and methods, according to embodiments of the present invention.

FIG. 3 illustrates aspects of folded mask systems and methods, according to embodiments of the present invention.

### DETAILED DESCRIPTION OF THE INVENTION

All illustrations of the drawings are to be describing selected embodiments of the present invention and are not intended to limit the scope of the present invention. All references of user or users pertain to either individual or individuals who would utilize embodiments of the present invention.

Embodiments of the present invention encompass folded masks that can be used by medical patients, healthcare workers, emergency personnel, and other individuals to prevent the inhalation or transmission of airborne particles such as viruses and other pathogens, as well as other potentially infectious or hazardous materials.

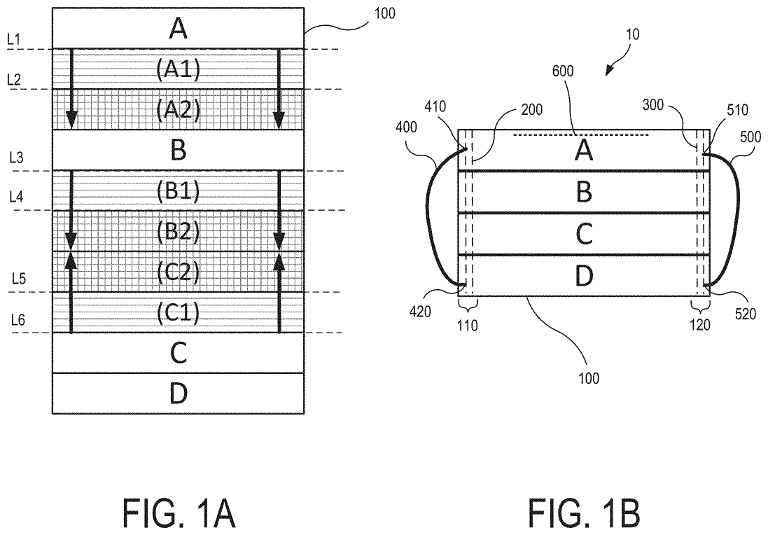

Turning now to the drawings, FIGS. 1A and 1B show a folding scheme for a mask panel 100, according to embodiments of the present invention. FIG. 1A shows the mask panel 100 in an unfolded configuration, with folding annotations indicated by directional arrows and fold lines L1, L2, L3, L4, L5, and L6. FIG. 1A also illustrates that mask panel 100 can include panel subsections, such as subsections A, A1, A2, B, B1, B2, C2, C1, C, and D. FIG. 1B illustrates the mask panel 100 in a folded configuration. Mask panel 100 can be combined with or attached to ear loops 400, 500 to form a mask 10. Once the mask panel 100 has been folded in the desired configuration, as depicted in FIG. 1B, seams 200, 300 can be introduced along the lateral portions 110, 120 of the panel 100. Optionally, ear loops 400, 500 can also be secured to the mask panel 100 by the seams 200, 300. In some cases, ear loops can include an elastic material. As shown here, ear loops are secured to the panel 100 at two locations or points. In the image provided by FIG. 1B, the mask 10 is viewed from the front, and the anterior faces of panel subsections A, B, C, and D are visible from the front.

Depending on the embodiment, the ear loops 400, 500 may be sewn or fused to the filter mask panel 100 (e.g. at lateral portions 110, 120) at upper points 410, 510 and lower points 420, 520, or simply passed through the panel 100 and knotted. In some cases, un-looped straps can be used instead of ear loops. The filter mask 10 may have any number of other features, including a metal strip or malleable mechanism 600 along the upper edge that can be used to conform the top of the filter mask 10 to the nose of the person wearing the mask.

In some embodiments, the finished product may be referred to as a mask 10. The mask 10 depicted here can be referred to as a medical mask, a filter mask, or a face mask. The unique folding aspect provided by opposing fold directions is further discussed below.

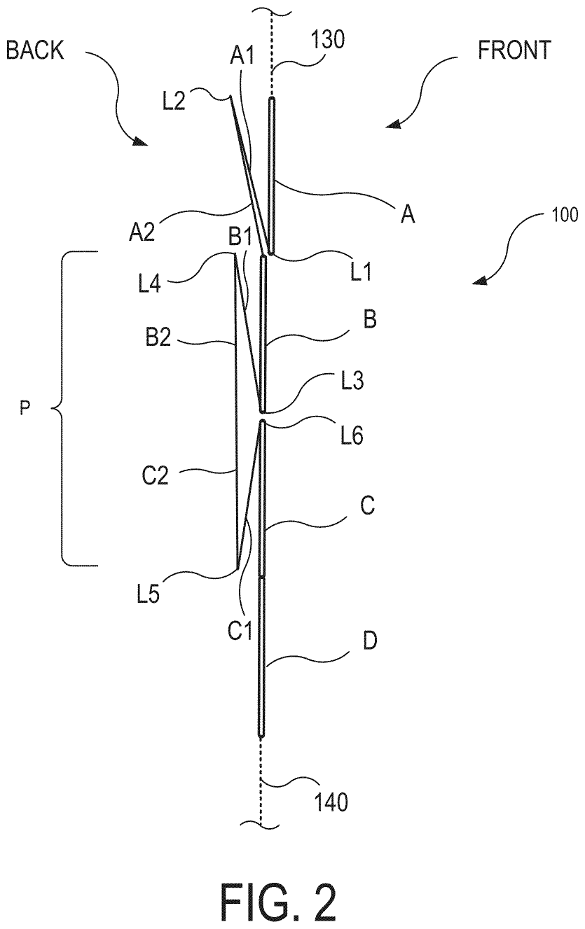

FIG. 2 schematically depicts a side view or cross-section of a lateral portion (e.g. 110, 120 as depicted in FIG. 1B) of a substantially folded mask panel 100, according to embodiments of the present invention. As shown here, the front or anterior side faces away from the wearer, and the back or posterior side faces toward the wearer. Fold lines (e.g. L1) and panel subsections (e.g. A) corresponding to those illustrated in FIG. 1A are illustrated as well. Optionally, the mask panel 100 may include additional panel material extending in the upward direction (130) or the downward direction (140).

The folded panel 100 provides certain unique structural features. For example, the back side includes a singular panel sub-portion P (e.g. combined sub-portions B2 and C2) that has a top edge or fold (e.g. at fold line L4) and a bottom edge or fold (e.g. at fold line L5) which fold away from the wearer's face (e.g. such that sub-portions B1 and C1 do not contact the wearer's face). This singular panel sub-portion P provides a large zone of contact with the wearer's face (e.g. particularly at the lateral portions or edges of the mask panel), thus improving the fit of the mask. For example, both the top edge (e.g. at fold line L4) and the bottom edge of sub-portion P (e.g. at fold line L5), as well as the portion between the top and bottom edges, can directly contact the wearer's face. This configuration can help to prevent or eliminate unwanted bulging of the mask, particularly toward the left and right edges of the mask in the area between the two attachment points (e.g. 410-420, 510-520 depicted in FIG. 1B) where ear loops or straps connect with the mask panel. Such bulging is undesirable because it leaves gaps that could allow pathogens or other potentially infectious or hazardous materials to enter or exit. As shown in FIG. 2, anterior to sub-portion P, there are two non-continuous exterior sub-portions (e.g. sub-portions B and C) that form an exterior surface of the mask panel. It can be seen that fold lines L3 and L6 can be adjacent to one another when the panel is in a folded configuration, with intervening subsections B1, B2, C2, and C1 therebetween, while intervening subsections B1, B2, C2, and C1 are also posterior to subsections B and C.

Unlike certain traditional masks which contain three folds that all bend in the same downward direction, embodiments of the present invention encompass mask panels having fold configurations where a bottom or lower fold (e.g. L6) is folded down in the opposite direction of a top or upper fold (e.g. L1 and/or L3) thus increasing and securing the feel of the mask on the lateral aspect of the panel (e.g. along lateral portions 110, 120). In this sense, the fold provided by fold lines L5 and L6 (∧) is reverse or inverted to the fold provided by fold lines L1 and L2 (∨), and is also reverse or inverted to the fold provided by fold lines L3 and L4. Related, it can be seen that the fold at L6 is in the ∧ configuration and the fold at L5 is in the ∨ configuration, whereas the fold at L1 is in the ∨ configuration and the fold at L2 is in the opposite or inverted ∧ configuration. Further, as shown here, the folds at fold lines L2 and L4 are in the ∧ configuration and the folds at fold lines L3 and L5 are in the V configuration. Hence, going from an upper portion of the mask panel toward a lower portion of the mask pane, the fold configurations or orientations can be in an alternating sequence, such as L1 ∨, L2 ∧, L3 ∨, L4 ∧, L5 ∨, and L6 ∧. As noted above, such fold configurations provide improved fit with the wearer's face. For example, the folding configurations disclosed herein enable a large portion of the mask panel (e.g. along the lateral portions) to lay flat against the wearer's face in a continuous fashion, and not bunch up or provide exposed gaps. As noted above, traditional surgical mask designs having three folds which are oriented in the same downward direction allow the mask to bunch up on the side thus preventing the mask from laying flat against the wearer's face. The folding configurations disclosed herein enable closer contact between the lateral portions of the mask panel and the wearer's face, improving the ability of the mask to protect the wearer and other individuals who may be in proximity with the wearer.

According to some embodiments, the fold provided by fold lines L5 and L6 is situated near the bottom of the mask panel and/or near the wearer's chin. This fold can decrease the dead space between the mask panel and the wearer's cheeks as well as increase the contact area of the mask with the chin and under chin area. In some cases, this fold can be attached via adhesive or Velcro to other portions of the mask panel.

The exemplary folding configurations depicted herein can also provide additional lateral support to the mask. In some cases, such folding configurations can provide a “cup” like interface against the wearer's face, in contrast to other known configurations which provide a “stair-step” like interface against the wearer's face. In some cases, such folding configurations are particularly well suited for use with wearers who have small and/or narrow faces, including children.

As noted above with reference to FIG. 1B, when the mask panel 100 is folded in the desired configuration, seams 200, 300 can be introduced along the lateral portions 110, 120 of the panel 100. In some cases, ultrasonic welding can be used to produce such seams. In some cases, stitching may be used to produce such seams. In some cases, other types of seam-forming processes and/or seam materials can be used to produce such seams. In some cases, the lateral portions 110, 120 may include an elastic material. In some cases, the seam-forming material can include an elastic material.

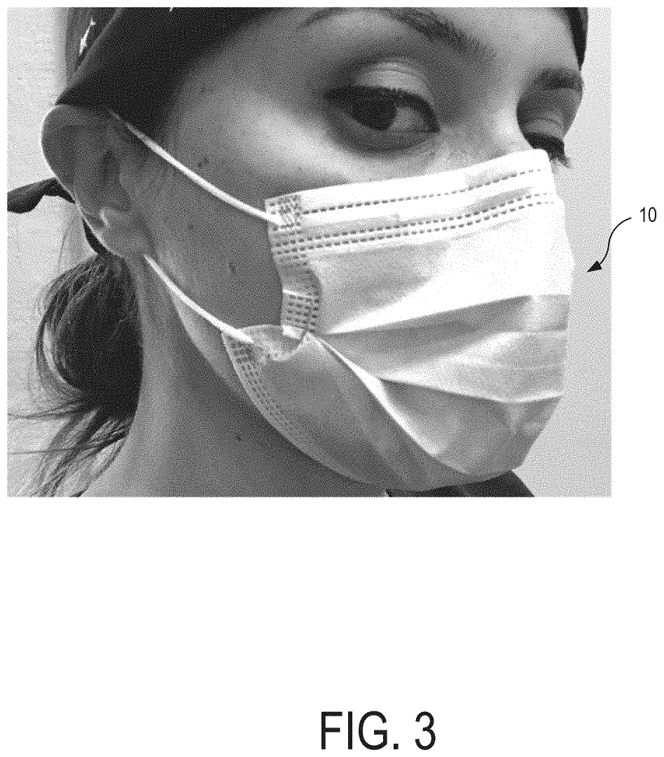

FIG. 3 depicts a person wearing a mask 10 according to embodiments of the present invention. Mask 10 can include any one or more of the features described in FIG. 1A, FIG. 1B, and/or FIG. 2. In some embodiments, a filter mask 10 can include a pleated sheet or panel of natural or polymer fibers that is extended over the nose and the mouth, down to and beyond the level of the chin. Any of a variety of materials may be used to construct the filter mask 10. The material of which the filter mask 10 is made may depend on any number of factors, including the size of particulate or aerosol matter that the filter mask 10 is intended to filter.

Although embodiments of the present invention have been explained in relation to one or more preferred embodiments, it is to be understood that many other possible modifications and variations can be made without departing from the spirit and scope of the invention.

All features of the described systems and devices are applicable to the described methods mutatis mutandis, and vice versa. Embodiments of the present invention encompass kits having systems for filtering breathing air as disclosed herein. In some embodiments, the kit includes one or more systems for filtering breathing air, along with instructions for using the system for example according to any of the methods disclosed herein. As described in this disclosure, in some embodiments the terms sub-portion and subsection may be used interchangeably.

Although the foregoing invention has been described in some detail by way of illustration and example for purposes of clarity of understanding, one of skill in the art will appreciate that certain changes, modifications, alternate constructions, and/or equivalents may be practiced or employed as desired, and within the scope of the appended claims. In addition, each reference provided herein in incorporated by reference in its entirety to the same extent as if each reference were individually incorporated by reference. Relatedly, all publications, patents, patent applications, journal articles, books, technical references, and the like mentioned in this specification are herein incorporated by reference to the same extent as if each individual publication, patent, patent application, journal article, book, technical reference, or the like was specifically and individually indicated to be incorporated by reference.

1. (canceled)

2. A folded face mask device, comprising:
a panel having a first subsection, a second subsection, a third subsection, an fourth subsection, a fifth subsection, a sixth subsection, a seventh subsection, an eighth subsection, a ninth subsection, a first fold line disposed between the first subsection and the second subsection, a second fold line disposed between the second subsection and the third subsection, a third fold line disposed between the fourth subsection and the fifth subsection, a fourth fold line disposed between the fifth subsection and the sixth subsection, a fifth fold line disposed between the seventh subsection and the eighth subsection, and a sixth fold line disposed between the eight subsection and the ninth subsection;
a first ear loop coupled with a first lateral portion of the panel; and
a second ear loop coupled with a second lateral portion of the panel opposite the first lateral portion of the panel;
wherein a posterior surface of the first subsection faces toward a posterior surface of the second subsection by virtue of the first fold line,
wherein an anterior surface of the second subsection faces toward an anterior surface of the third subsection by virtue of the second fold line,
wherein a posterior surface of the fourth subsection faces toward a posterior surface of the fifth subsection by virtue of the third fold line,
wherein an anterior surface of the fifth subsection faces toward an anterior surface of the sixth subsection by virtue of the fourth fold line,
wherein an anterior surface of the seventh subsection faces toward an anterior surface of the eighth subsection by virtue of the fifth fold line, and
wherein a posterior surface of the eighth subsection faces toward a posterior surface of the ninth subsection by virtue of the sixth fold line.

3. The folded face mask device of claim 2, wherein the third fold line and the sixth fold line are adjacent to one another.

4. The folded face mask device of claim 2, wherein a first fold provided by the first fold line and the second fold line is reverse to a second fold provided by the third fold line and the fourth fold line.

5. The folded face mask device of claim 2, wherein a first fold provided by the first fold line and the second fold line is reverse to a second fold provided by the fifth fold line and the sixth fold line.

6. The folded face mask device of claim 2, wherein a first fold provided by the first fold line and the second fold line is reverse to a second fold provided by the third fold line and the fourth fold line, and is also reverse to a third fold line provided by the fifth fold line and the sixth fold line.

7. A folded face mask device, comprising:
a panel having a first subsection, a second subsection, a third subsection, an fourth subsection, a fifth subsection, a sixth subsection, a seventh subsection, an eighth subsection, a ninth subsection, a first fold line disposed between the first subsection and the second subsection, a second fold line disposed between the second subsection and the third subsection, a third fold line disposed between the fourth subsection and the fifth subsection, a fourth fold line disposed between the fifth subsection and the sixth subsection, a fifth fold line disposed between the seventh subsection and the eighth subsection, and a sixth fold line disposed between the eight subsection and the ninth subsection;
a first strap coupled with a first lateral portion of the panel; and
a second strap coupled with a second lateral portion of the panel opposite the first lateral portion of the panel;
wherein a posterior surface of the first subsection faces toward a posterior surface of the second subsection by virtue of the first fold line,
wherein an anterior surface of the second subsection faces toward an anterior surface of the third subsection by virtue of the second fold line,
wherein a posterior surface of the fourth subsection faces toward a posterior surface of the fifth subsection by virtue of the third fold line,
wherein an anterior surface of the fifth subsection faces toward an anterior surface of the sixth subsection by virtue of the fourth fold line,
wherein an anterior surface of the seventh subsection faces toward an anterior surface of the eighth subsection by virtue of the fifth fold line, and
wherein a posterior surface of the eighth subsection faces toward a posterior surface of the ninth subsection by virtue of the sixth fold line.

8. The folded face mask device of claim 7, wherein the third fold line and the sixth fold line are adjacent to one another.

9. The folded face mask device of claim 7, wherein a first fold provided by the first fold line and the second fold line is reverse to a second fold provided by the third fold line and the fourth fold line.

10. The folded face mask device of claim 7, wherein a first fold provided by the first fold line and the second fold line is reverse to a second fold provided by the fifth fold line and the sixth fold line.

11. The folded face mask device of claim 7, wherein a first fold provided by the first fold line and the second fold line is reverse to a second fold provided by the third fold line and the fourth fold line, and is also reverse to a third fold line provided by the fifth fold line and the sixth fold line.

12. A folded face mask device, comprising:
a panel having a first subsection, a second subsection, a third subsection, an fourth subsection, a fifth subsection, a sixth subsection, a seventh subsection, an eighth subsection, a ninth subsection, a first fold line disposed between the first subsection and the second subsection, a second fold line disposed between the second subsection and the third subsection, a third fold line disposed between the fourth subsection and the fifth subsection, a fourth fold line disposed between the fifth subsection and the sixth subsection, a fifth fold line disposed between the seventh subsection and the eighth subsection, and a sixth fold line disposed between the eight subsection and the ninth subsection;
wherein a posterior surface of the first subsection faces toward a posterior surface of the second subsection by virtue of the first fold line,
wherein an anterior surface of the second subsection faces toward an anterior surface of the third subsection by virtue of the second fold line,
wherein a posterior surface of the fourth subsection faces toward a posterior surface of the fifth subsection by virtue of the third fold line,
wherein an anterior surface of the fifth subsection faces toward an anterior surface of the sixth subsection by virtue of the fourth fold line,
wherein an anterior surface of the seventh subsection faces toward an anterior surface of the eighth subsection by virtue of the fifth fold line, and
wherein a posterior surface of the eighth subsection faces toward a posterior surface of the ninth subsection by virtue of the sixth fold line.

13. The folded face mask device of claim 12, wherein the third fold line and the sixth fold line are adjacent to one another.

14. The folded face mask device of claim 12, wherein a first fold provided by the first fold line and the second fold line is reverse to a second fold provided by the third fold line and the fourth fold line.

15. The folded face mask device of claim 12, wherein a first fold provided by the first fold line and the second fold line is reverse to a second fold provided by the fifth fold line and the sixth fold line.

16. The folded face mask device of claim 12, wherein a first fold provided by the first fold line and the second fold line is reverse to a second fold provided by the third fold line and the fourth fold line, and is also reverse to a third fold line provided by the fifth fold line and the sixth fold line.

17. The folded face mask device of claim 12, further comprising a first ear loop coupled with a first lateral portion of the panel, and a second ear loop coupled with a second lateral portion of the panel opposite the first lateral portion of the panel.

18. The folded face mask device of claim 17, wherein the first ear loop is coupled with the first lateral portion of the panel via a first seam, and wherein the second ear loop is coupled with the second lateral portion via a second seam.

19. The folded face mask device of claim 12, further comprising a first strap coupled with a first lateral portion of the panel, and a second strap coupled with a second lateral portion of the panel opposite the first lateral portion of the panel.

20. The folded face mask device of claim 19, wherein the first strap is coupled with the first lateral portion of the panel via a first seam, and wherein the second strap is coupled with the second lateral portion via a second seam.

21. The folded face mask device of claim 12, further comprising a malleable mechanism disposed along an upper edge of the panel.
